(19) United States
(12) Patent Application Publication
(10) Pub. No.: US 2005/0233168 A1
(43) Pub. Date: Oct. 20, 2005

(54) Method of aligning an OLED and device made

(76) Inventors: John N. Magno, Middletown, NJ (US); Zhijian Lu, Belle Mead, NJ (US)

Correspondence Address: Ronald D. Trice, PMB 138, 2101 Crystal Plaza Arcade, Arlington, VA, 22202-4600, US

(21) Appl. No.: 11/035,061

(22) Filed: Jan. 14, 2005

Related U.S. Application Data
(60) Provisional application No. 60/563,343, filed on Apr. 16, 2004.

(51) Int. Cl. H05B 33/14; H05B 33/10

(52) U.S. Cl. 428/690; 428/917; 313/504; 313/506; 427/66

(57) ABSTRACT

The present invention relates to an organic light emitting device having an emitting layer including a photoalignable organic light emitting material, and the method of aligning the photoalignable organic light emitting material and fabricating devices including such a material.

### RELATED APPLICATIONS

This application claims priority from, and incorporates by reference, U.S. Provisional application Ser. No. 60/563,343, filed Apr. 16, 2004.

### FIELD OF THE INVENTION

The present invention relates generally to aligning the emitting layers of organic light emitting devices (OLEDs) and the OLEDs thereby fabricated.

### BACKGROUND

An anisotropically emitting organic light emitting device (OLED) includes a number of layers. One such layer is the alignment layer. Currently used alignment layers include rubbed alignment layers and photoalignment layers. Depending upon the application and structure of the OLED, different alignment techniques are preferable over others. However, the number of OLED alignment techniques is currently limited. Accordingly, there is a strong need in the art for additional techniques to provide alignment in anisotropically emitting OLEDs.

### SUMMARY OF THE INVENTION

An aspect of the present invention is to provide an organic light emitting device including an anode, a cathode, and an emitting layer including an alignable organic light emitting compound and a photoalignment compound. The photoalignment compound aligns the alignable organic light emitting compound after irradiated with polarized ultra-violet light. The alignable organic light emitting compound and the photoalignment compound may form a polymer or a mixture. The alignable organic light emitting compound may form a polymer after being irradiated with the polarized ultra-violet light or may form a polymer after being irradiated with a subsequent ultra-violet light having a wavelength different than the polarized ultra-violet light. The alignable organic light emitting compound need not form a polymer. The alignable organic light emitting compound may be formed from 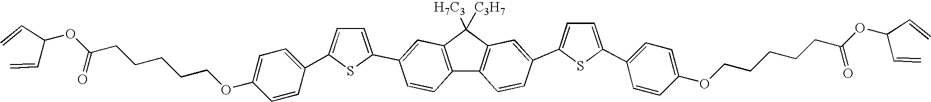
or may be 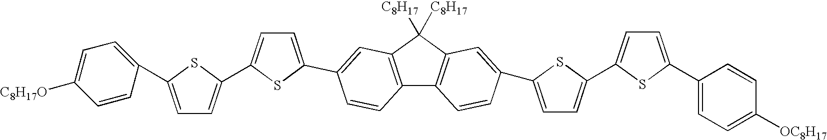
or may be formed from 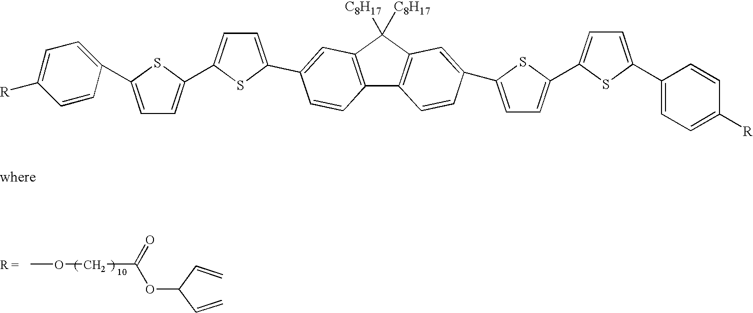
may be polymerized to form a crosslinked polymer layer. The photoalignment compound may have the following formula 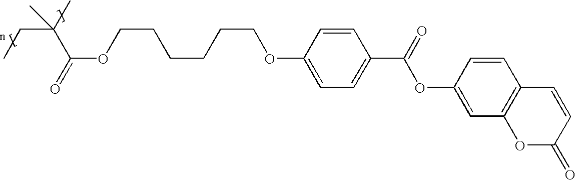
The photoalignment compound may be a coumarin side-chain molecule. The alignable organic light emitting compound may have a liquid crystalline phase.

Another aspect of the present invention is to provide a method of making an organic light emitting device including mixing an alignable organic light emitting compound and a photoalignment compound, depositing the alignable organic light emitting compound and the photoalignment compound on a surface, and aligning the photoalignment compound with a polarized light source. The alignable organic light emitting compound and the photoalignment compound are copolymerized to form a polymer. The alignable organic light emitting compound and the photoalignment compound are a mixture. The alignable organic light emitting compound may form a polymer after being irradiated with the polarized ultra-violet light or may form a polymer after being irradiated with a subsequent ultra-violet light having a wavelength different than the polarized ultra-violet light. The alignable organic light emitting compound need not form a polymer. The alignable organic light emitting compound is 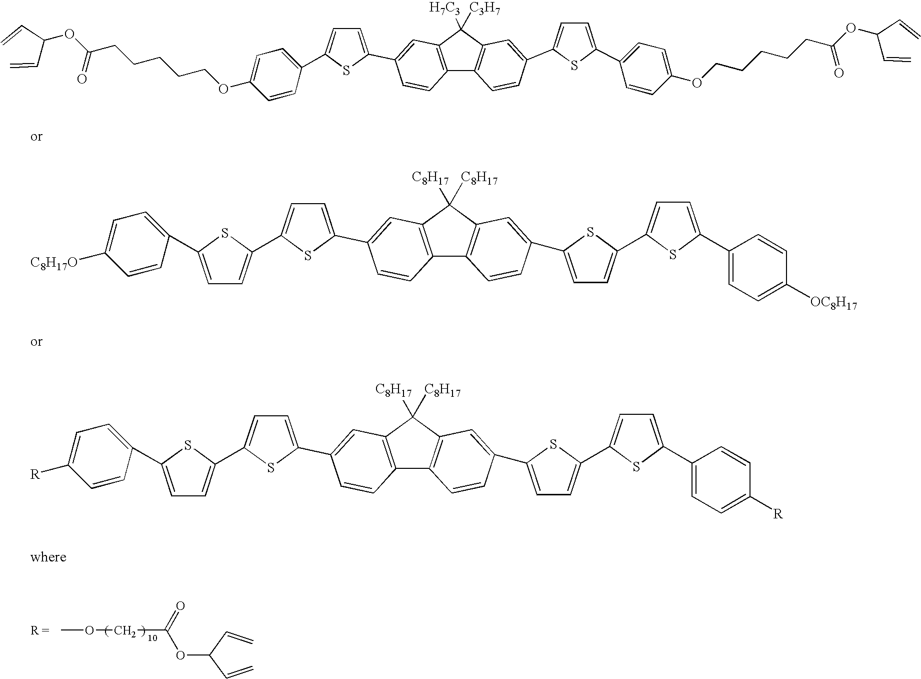
forms crosslinked polymer after being irradiated with ultra-violet light. The photoalignment compound may have the following formula 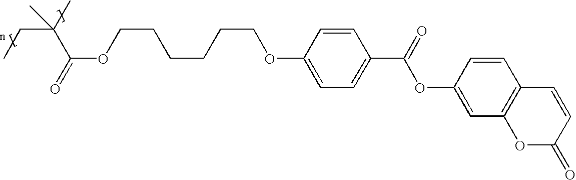
The photoalignment compound may be a coumarin side-chain molecule. The photoalignable organic light emitting compound may have a liquid crystalline phase.

### BRIEF DESCRIPTION OF THE DRAWINGS

The invention will be described in detail with reference to the following drawings in which like reference numerals refer to like elements wherein:

FIG. 1 illustrates an exemplary OLED having photoalignable organic light emitting material;

FIG. 2 illustrates a deposition of the photoalignable organic light emitting material; and

FIG. 3 illustrates the emitting material layer being aligned by a polarized light source.

### DETAILED DESCRIPTION

Anisotropically emitting OLEDs typically include aligned light emitting materials. Previously, a separate alignment layer to align the light emitting materials was used. The inclusion of separate alignment layers in the devices may be disadvantageous because of efficiency, yield, cost, or other considerations. An alternative to such a separate alignment layer is to incorporate an alignment material into the layer to be aligned. For example, an alignment compound may be chemically incorporated into a layer to be aligned. Such a layer may be formed from at least one alignable electroluminescent compound that is polymerizable under the radiation of ultra-violet light or other suitable radiation (e.g., an electroluminescent liquid crystalline monomer compound). Similarly, an alignment compound could be mixed into the layer to be aligned and then exposed to polarized ultra-violet light or other suitable radiation such that the layer also becomes aligned. In such a mixed layer, the photoalignment compound and the remaining material of the aligned layer would be chemically separate. Alternatively, the aligned layer could include alignment material of both types.

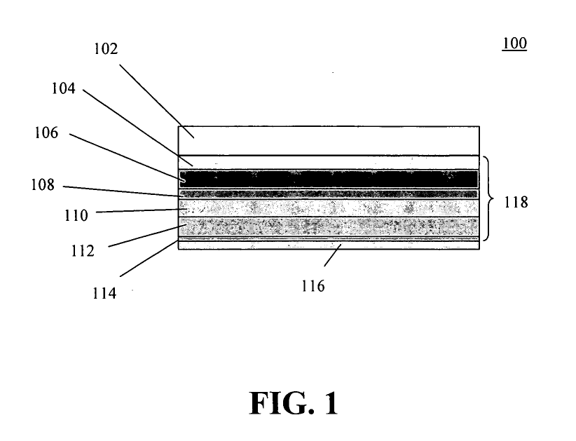

FIG. 1 illustrates an exemplary device 100 including photoalignable organic light emitting materials. The device 100 includes a transparent substrate 102, an anode 104, a hole injection layer 106, a hole transport layer 108, an emitting layer (which may also be referred to as a photoalignable organic light emitting layer) 110, an electron transport layer 112, an electron injection layer 114, and a cathode 116. The anode 104, hole injection layer 106, hole transport layer 108, emitting layer 110, electron transport layer 112, electron injection layer 114, and cathode 116 form an organic light emitting device (OLED) 118. The anode 104 may be made from indium-tin oxide or another suitable transparent, conductive material. The cathode 116 may be made from a low work function metal such as aluminum, silver, magnesium/silver alloy, or another suitable material. The device may be bottom emitting, top emitting, transparent or edge emitting depending on the anode and cathode material selection and the design of electrodes and/or other layers of the device 100. The emitting layer 110 may be made from the photoalignable light emitting materials disclosed herein or any other suitable materials. The other layers of the OLED 118 may be formed from any of the suitable materials that are known in the art. Alternatively, additional layers, such as a hole blocking layer, may be included in the device 100 and one or more of the illustrated layers may be omitted.

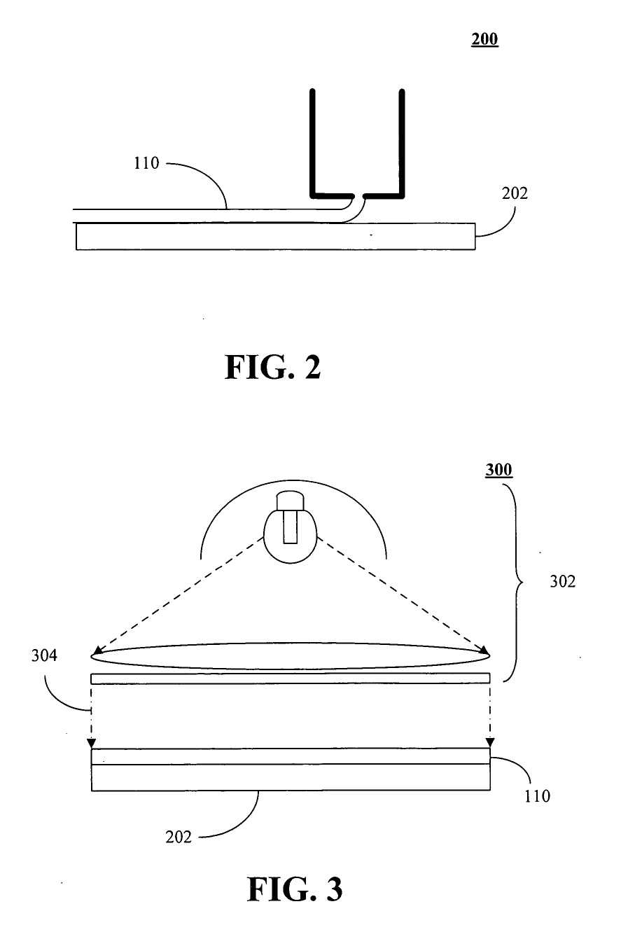

FIG. 2 illustrates a deposition step 200 of the photoalignable organic light emitting material layer 110. The various layers of the device 100 other than the photoalignable organic light emitting layer 110 are fabricated according to known methods. The photoalignable emitting material layer 110 is deposited on the partially completed device 202. The partially finished device 202 may include anode and hole injection/transport layer. This deposition 200 may be performed according to known methods or any other any suitable technique except that the emitting layer 110 is deposited as a material containing electroluminescent molecule group and photoalignment molecule group, either physically mixed, or chemically bonded or both. For example, spin coating or inkjet printing may be used.

Next, the deposited photoalignable organic light emitting layer 110 is aligned by a polarized light source 302 in an alignment step 300, as illustrated in FIG. 3. In the alignment step 300, the polarized light source 302 produces polarized light 304. The polarized light 304 irradiates the photoalignable organic light emitting layer 110 and causes the material of the photoalignable organic light emitting layer 110 to become aligned. The polarized light 304 may be used to polymerize the material of the photoalignable organic light emitting layer 10 when the material is polymerizable. The remaining portions of such an OLED, e.g. electron transport and electron injection layers, may be fabricated according to known methods.

Suitable materials that may be used to form the photoalignable organic light emitting layer 10 include, but are not limited to, organic light emitting materials having a calamitic liquid crystalline structure. These materials may advantageously have high charge transport property and low self absorption. For example, 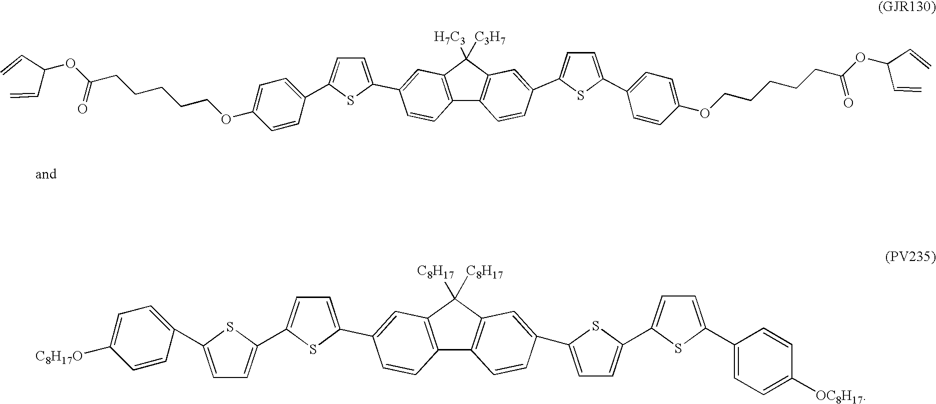
These materials may be fabricated as thin layers (equal to or less than 40 nm) or may be deposited as thick layers (greater than 40 nm). Alternatively, other materials may be used. For example, PV237, poly(9,9-dioctylfluorene-co-benzothiadiazole), poly(9,9-dioctylfluorene-co-dithiophene), and 2-(4′-heptylbiphenyl-4-yl)-5-(4-N,N-dimethylaminophenyl)-1,3,4-oxadiazole (7-OXD-Me).

If polymerizable materials are used to form the photoalignable organic light emitting layer 110, the photoalignment compound may be incorporated into the polymeric chain. If non-polymerizable materials are used to form photoalignable organic light emitting layer 110, the photoalignment compound will be mixed in with the light emitting material. In either case, a polarized light source may be used to impart an alignment to the photoalignment compound. The polarized light may also be used to polymerize the light emitting material. The polarized light source may be a UV source or any other suitable light source. For example, the polarized light source may be an Argon Ion laser (300 nm), XeCl excimer laser (308 nm), or filtered emission from mercury lamp (365 nm). The light source may be polarized with a non-absorptive (e.g. crystal) polarizer such that polarized light with high extinction ratio results.

### EXAMPLE 1

An OLED may be formed by including a distributed Bragg reflector (DBR), an indium tin oxide (ITO) as anode 104, a hole injection/transport layer 106, 108 of poly(3,4-ethylenedioxythiophene) poly(styrenesulfonate) (PEDOT/PSS), an emitting material layer 110 of GJR130 and coumarin based side chain compound, an electron injection layer 114 of LiF, and an aluminum electrode/reflector 116.

### EXAMPLE 2

An OLED may be formed by including a DBR that reflects most (e.g., 98%) of the light incident thereon, an ITO electrode 104, a hole injection/transport 106, 108 of PEDOT/PSS, an emitting material layer of PV235 and courmarin based side chain compound, a hole blocking layer of 3-(4-Biphenylyl)-4-phenyl-5-tert-butylphenyl-1,2,4-triazole (TAZ), an electron injection layer 114 of LiF, and an aluminum electrode/reflector 116.

### EXAMPLE 3

An OLED may be formed by including a DBR, an ITO electrode 104, a hole injection/transport layer 106, 108 of PEDOT/PSS, an emitting material layer 110 of PV235 and coumarin based side chain compound, a hole blocking layer of TAZ, an electron injection layer 114 of CsF, and an aluminum electrode/reflector 116.

### EXAMPLE 4

An OLED may be formed by including an ITO electrode, a hole injection/transport layer of PEDOT/PSS, an emitting material layer 110 of PV235 and coumarin based side chain compound, a hole blocking layer of TAZ, an electron injection layer 114 of LiF, and an aluminum electrode/reflector 116.

### EXAMPLE 5

An OLED may be formed by including an ITO electrode, a hole injection/transport layer of PEDOT/PSS, an emitting material layer of GJR130 and coumarin based side chain compound, an electron injection layer of LiF, and an aluminum electrode/reflector.

Various additional structures may be included in OLEDs including, but are not limited, to substrates, hole injection layers, hole transport layers, electron transport layers, electron injection layers, light coupling layers, reflectors, partial reflectors, distributed Bragg reflectors, driving elements and buses, color filters, polarizers, antireflective layers, antiglare layers, waveguides, black matrixes, alignment layers, moisture barriers, and any other structure usable in an OLED device.

TAZ (3-(4-Biphenylyl)-4-phenyl-5-tert-butylphenyl-1,2,4-triazole) is available from H. W. Sands Corp. of Florida. The PEDOT/PSS (poly(3,4-ethylenedioxythiophene) poly(styrenesulfonate)) is available from the Bayer Group.

GJR130 has the formula: 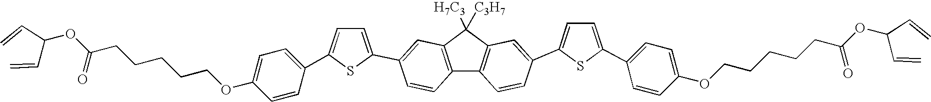
and is more fully discussed in U.S. patent application Ser. Nos. 10/187,381 and 10/187,396, which are incorporated herein in their entirety by this reference. PV235 and PV237 may be synthesized and have the formulas as indicated below: 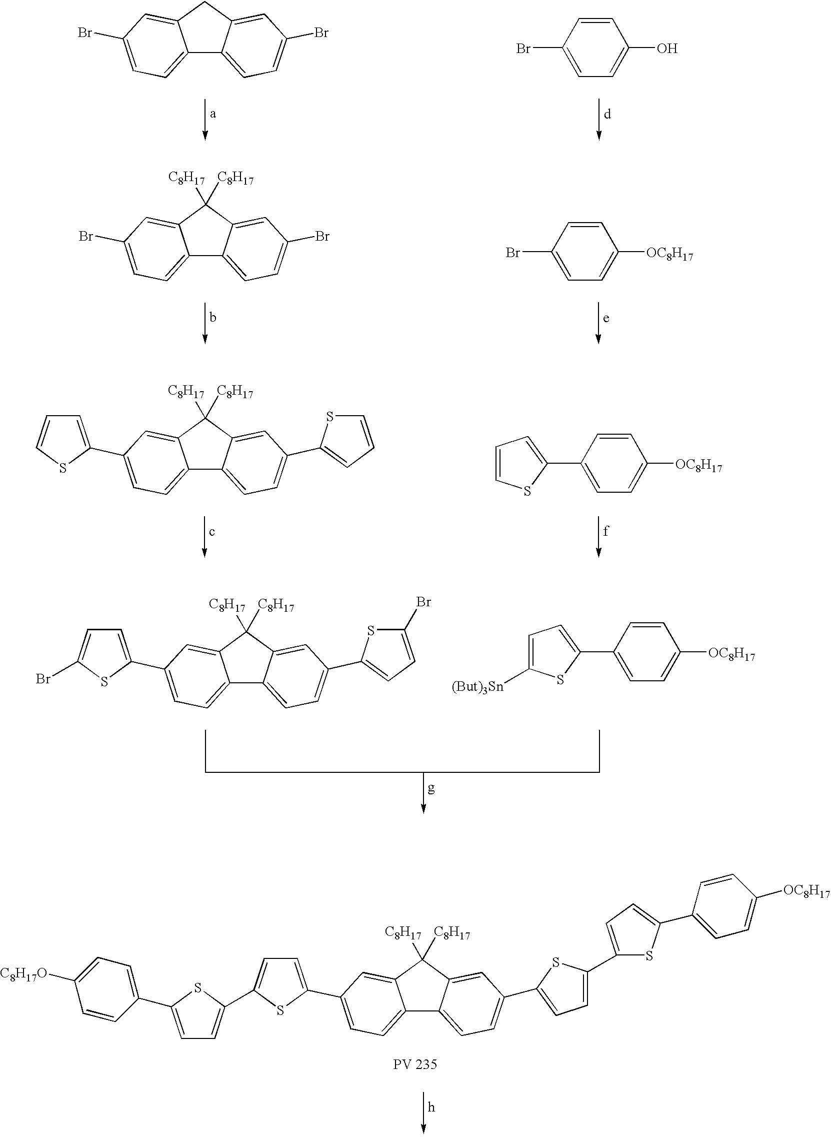 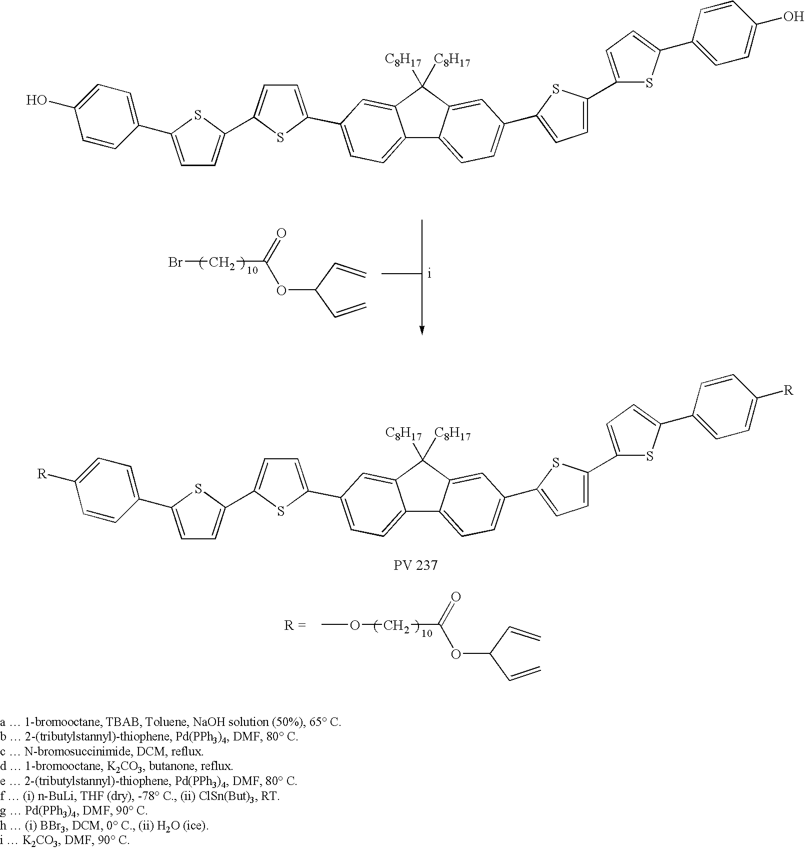
GJR130, PV235, and PV237 have the added advantage of having calamitic liquid crystalline structure at about room temperature.

Poly(9,9-dioctylfluorene-co-benzothiadiazole) has the formula 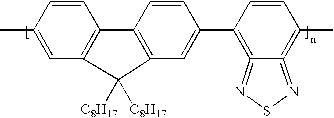
and Poly(9,9-dioctylfluorene-co-dithiophene) has the formula 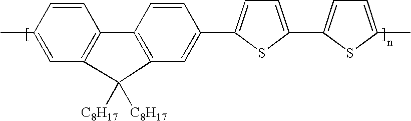
Poly(9,9-dioctylfluorene-co-benzothiadiazole) and Poly(9,9-dioctylfluorene-co-dithiophene) are further discussed in Grell & Bradley; J. of Korean Physical Society, Vol. 36, No. 6, June 2000, pp. 331-336, which are incorporated herein by reference.

2-(4′-heptylbiphenyl-4-yl)-5-(4-N,N-dimethylaminophenyl)-1,3,4-oxadiazole (7-OXD-Me) has the formula 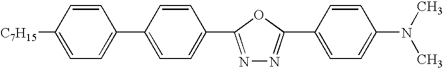
and is further discussed in Kawamoto, etc. J. of Applied Physics, Vol. 94, No 10, November 2003, pp. 6442-6446), which is incorporated herein by reference.

Suitable photoalignment molecule groups include 7-hydroxycoumarin which has the following formula 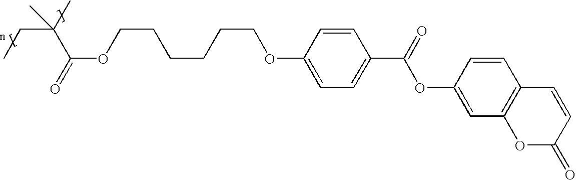
and coumarin side-chain molecules of Rolic LTD which polymerizes as shown below. 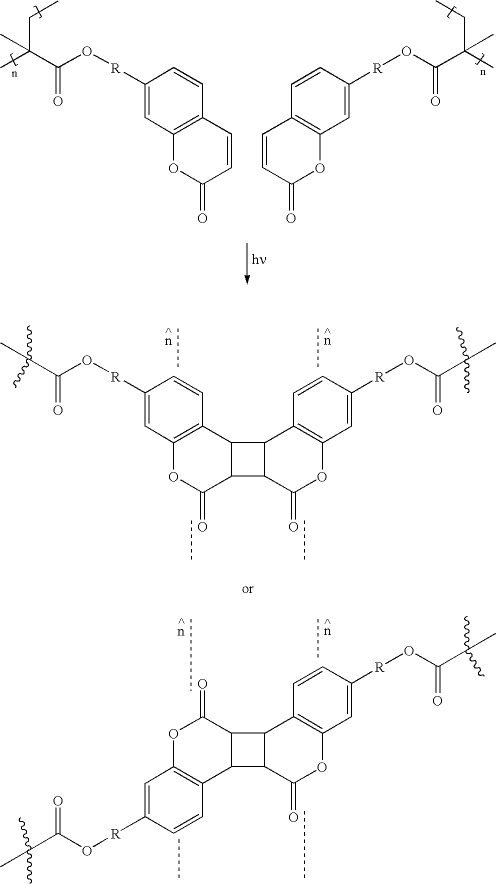
Any other suitable alignment material also may be used.

The LiF and Aluminum are available from SigmaAldrich. The DBR is distributed Bragg reflector having alternating quarter wave layers of SiO₂ and Ta₂O₅.

The ITO coated glass substrates are available from Applied Films of Colorado. The sheet resistance of this ITO is specified to <20 Ω/□. These ITO coated glass substrates undergo solution cleaning, drying, and then oxygen plasma cleaning. PEDOT/PSS layer then may be spin coated and dried using a hot plate with temperature set at 150° C. for 10 minutes. Subsequent photoalignable organic light emitting material may be spin coated and dried in a nitrogen glove box. The thus prepared substrate then may be sealed with N₂ and transferred to a vacuum deposition chamber. Polarized ultra-violet light may pass through the quartz window of the vacuum chamber and induce the alignment of the organic light emitting material. A separate environment, for example vacuum, nitrogen, argon, an inert gas or other suitable environment, Subsequently TAZ, LiF, and Aluminum layers are deposited in the chamber with vacuum level controlled to ˜10⁻⁶ torr. The finished device may be packaged with moisture resistant gasket in an Argon filled glove box.

Although certain OLED materials have been disclosed herein, the present invention is not limited to these materials and any other suitable material may be used. For example, the other materials disclosed in U.S. patent application Ser. Nos. 10/187,381, 10/187,396 and 60/563,343 also may be used.

Although several embodiments of the present invention and its advantages have been described in detail, it should be understood that changes, substitutions, transformations, modifications, variations, permutations, and alterations may be made therein without departing from the teachings of the present invention or the spirit and scope of the invention being set forth by the appended claims.

1. An organic light emitting device comprising:
an anode and a cathode; and
an emitting layer including an alignable organic light emitting compound and a photoalignment compound.

2. The device of claim 1, wherein the photoalignment compound aligns the alignable organic light emitting compound after irradiated with polarized ultra-violet light.

3. The device of claim 2, wherein the alignable organic light emitting compound and the photoalignment compound form a polymer.

4. The device of claim 2, wherein the alignable organic light emitting compound and the photoalignment compound are a mixture.

5. The device of claim 4, wherein the alignable organic light emitting compound forms a polymer after being irradiated with the polarized ultra-violet light.

6. The device of claim 4, wherein the alignable organic light emitting compound forms a polymer after being irradiated with a subsequent ultra-violet light having a wavelength different than the polarized ultra-violet light.

7. The device of claim 4, wherein the alignable organic light emitting compound does not form a polymer.

8. The device of claim 1, wherein the alignable organic light emitting compound is formed from 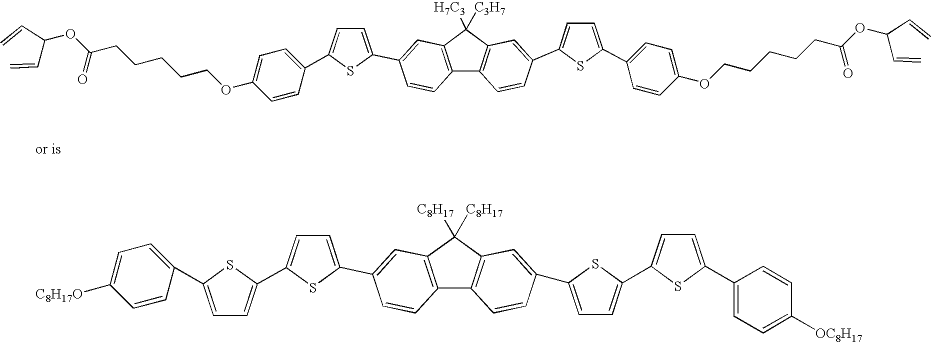
or is formed from

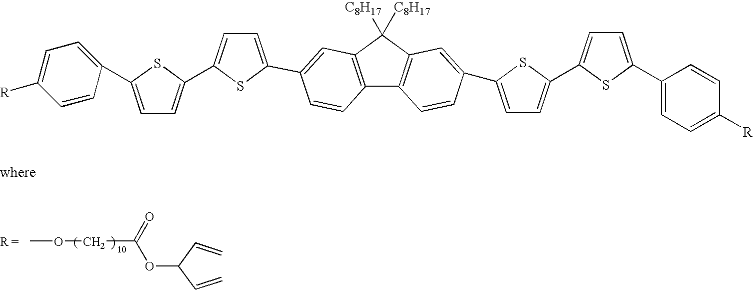

9. The device of claim 8, wherein the 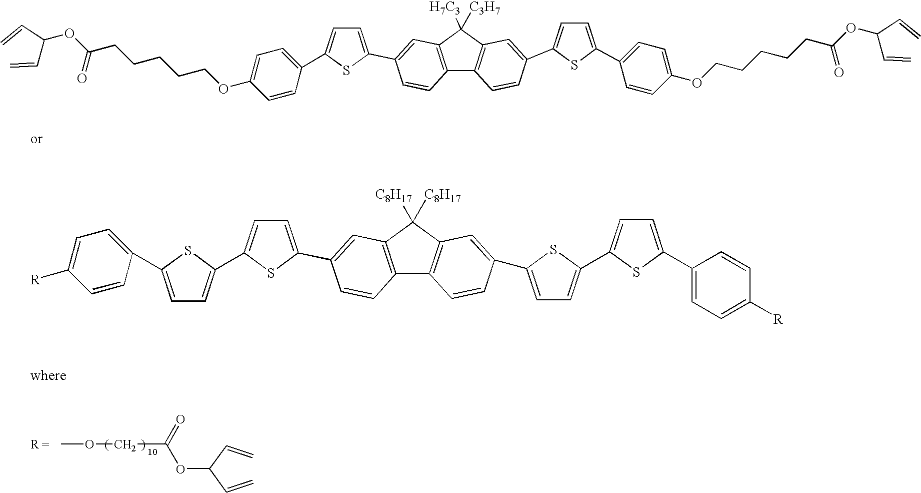
is polymerized to form a crosslinked polymer layer.

10. The device of claim 1, wherein the photoalignment compound has the following formula

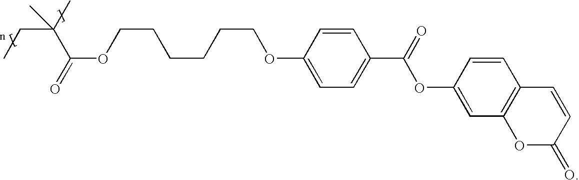

11. The device of claim 1, wherein the photoalignment compound is a coumarin side-chain molecule.

12. The device of claim 1, wherein the alignable organic light emitting compound has a liquid crystalline phase.

13. A method of making an organic light emitting device comprising:
mixing an alignable organic light emitting compound and a photoalignment compound;
depositing the alignable organic light emitting compound and the photoalignment compound on a surface; and
aligning the photoalignment compound with a polarized light source.

14. The method of claim 13, wherein the alignable organic light emitting compound and the photoalignment compound are copolymerized to form a polymer.

15. The method of claim 13, wherein the alignable organic light emitting compound and the photoalignment compound are a mixture.

16. The method of claim 15, wherein the alignable organic light emitting compound forms a polymer after being irradiated with the polarized ultra-violet light.

17. The method of claim 15, wherein the alignable organic light emitting compound forms a polymer after being irradiated with a subsequent ultra-violet light having a wavelength different than the polarized ultra-violet light.

18. The method of claim 15, wherein the alignable organic light emitting compound does not form a polymer.

19. The method of claim 13, wherein the alignable organic light emitting compound is

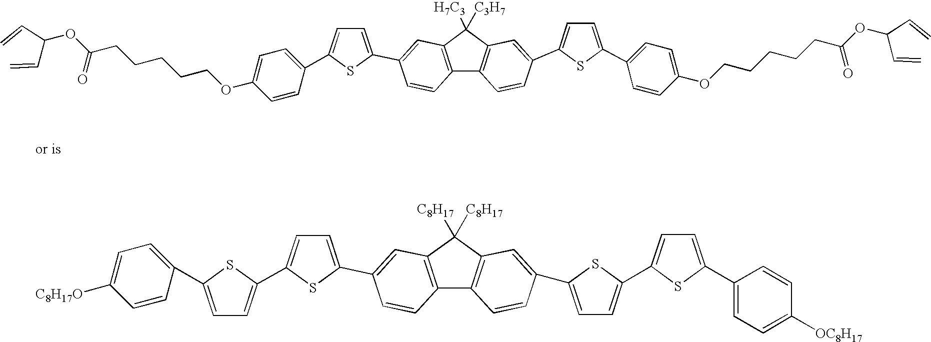

20. The method of claim 19, wherein the 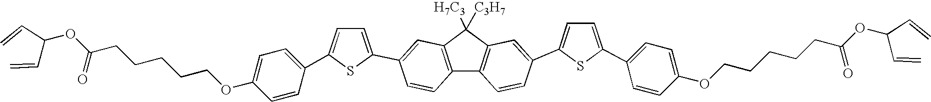
forms crosslinked polymer after being irradiated with ultra-violet light.

21. The method of claim 13, wherein the photoalignment compound has the following formula

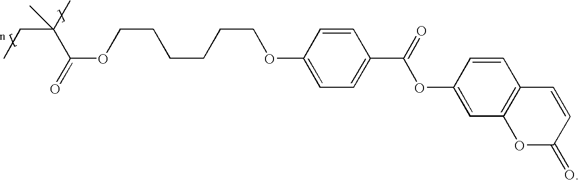

22. The method of claim 13, wherein the photoalignment compound is a coumarin side-chain molecule.

23. The method of claim 13, wherein the photoalignable organic light emitting compound has a liquid crystalline phase.
